(19) United States
(12) Patent Application Publication
(10) Pub. No.: US 2026/0211204 A1
(43) Pub. Date: Jul. 23, 2026

(54) VEHICULAR CAMERA

(71) Applicant: Panasonic Automotive Systems Co., Ltd., Kanagawa (JP)

(72) Inventors: Kouichi KAWAMOTO, Osaka (JP); Takahiro OOMORI, Fukuoka (JP); Satoshi KOBAYASHI, Kanagawa (JP); Shouichiro IKEDA, Kanagawa (JP)

(73) Assignee: Panasonic Automotive Systems Co., Ltd., Kanagawa (JP)

(21) Appl. No.: 19/446,406

(22) Filed: Jan. 12, 2026

(30) Foreign Application Priority Data
Jan. 20, 2025 (JP) 2025-007758

(51) Int. Cl. G02B 7/02; H04N 23/51; H04N 23/55

(52) U.S. Cl. CPC G02B 7/021; H04N 23/51; H04N 23/55

(57) ABSTRACT

A vehicular camera includes a lens barrel, an imaging element, a circuit board, a housing supporting the lens barrel and accommodating the imaging element and the circuit board, and a planar member disposed between a second end portion of a first tubular portion of the lens barrel and a first surface of the circuit board. The planar member includes a third surface, a fourth surface, and a light passage hole. The light passage hole includes a planar member inner surface connecting the third surface and the fourth surface of the planar member. Incident light incident on the first lens passes through the second lens and the light passage hole and reaches the imaging element, and outermost light of the incident light passes through a side closer to the optical axis than the planar member inner surface of the planar member.

### TECHNICAL FIELD

The present disclosure relates to a vehicular camera.

With demands for improvements in vehicle safety, introduction of autonomous driving functions and the like in recent years, development of vehicular cameras that are mounted on vehicles and capture the inside and outside of the vehicles has become active (for example, see Patent Literature 1).

### CITATION LIST

### PATENT LITERATURE

### Patent Literature 1: WO2024/004821

### SUMMARY OF INVENTION

Required levels relating to safety, automatic driving functions, and the like, which are required for vehicles, are improved, and further improvement in performance and the like are also required for vehicular cameras.

The present disclosure relates to a technique for providing a new vehicular camera.

A vehicular camera of the present disclosure includes a lens barrel including a first tubular portion having a first tubular shape along an optical axis and having a first end portion, a second end portion opposite to the first end portion, a lens barrel inner surface and a lens barrel outer surface, and a lens disposed inside the first tubular portion; an imaging element disposed on the optical axis and closer to the second end portion than the first end portion of the first tubular portion of the lens barrel; a circuit board having a first surface and a second surface opposite to the first surface, the imaging element being disposed on the first surface; a housing including a second tubular portion having a second tubular shape along the optical axis and having a third end portion and a fourth end portion opposite to the third end portion, and configured to support the lens barrel and accommodate at least the imaging element and the circuit board; and a planar member made of metal and disposed between the second end portion of the first tubular portion of the lens barrel and the first surface of the circuit board along a direction parallel to the first surface of the circuit board. The lens of the lens barrel includes a first lens disposed inside the first tubular portion and closer to the first end portion than the second end portion, and a second lens disposed inside the first tubular portion and closer to the second end portion than the first lens. The planar member includes a third surface, a fourth surface opposite to the third surface, and a light passage hole through which the optical axis passes and which penetrates the third surface and the fourth surface. The light passage hole includes a planar member inner surface connecting the third surface and the fourth surface of the planar member, and incident light incident on the first lens passes through the second lens and the light passage hole and reaches the imaging element, and outermost light, which is light located on an outermost side among the incident light, passes through a side closer to the optical axis than the planar member inner surface of the planar member.

According to the present disclosure, incident light can pass through a light passage hole without being obstructed by a planar member inner surface of a planar member.

### BRIEF DESCRIPTION OF DRAWINGS

FIG. 1 is an example of a vehicle, and is a top view of the vehicle on which vehicular cameras are mounted;

FIG. 2 is a block diagram illustrating a connection example of the vehicular cameras provided in the vehicle illustrated in FIG. 1, a camera ECU, and a display;

FIG. 3 is another example of the vehicle, and is a schematic diagram of a cabin of the vehicle on which a vehicular camera is mounted;

FIG. 4 is a top view of the vehicle in FIG. 3;

FIG. 5 is a block diagram illustrating a connection example of the vehicular camera provided in the vehicle illustrated in FIG. 3, a camera ECU, and a display device;

FIG. 6 is a front perspective view of the vehicular camera according to a first embodiment;

FIG. 7 is a rear perspective view of the vehicular camera according to the first embodiment;

FIG. 8 is an exploded perspective view of the vehicular camera according to the first embodiment;

FIG. 9 is a top view of the vehicular camera according to the first embodiment;

FIG. 10 is a cross-sectional view taken along a line I-I in FIG. 9;

FIG. 11 is a rear perspective view of a lens barrel in the vehicular camera according to the first embodiment;

FIG. 12 illustrates a state in which a planar member is attached to the lens barrel of FIG. 11;

FIG. 13 is an image diagram illustrating an optical path of incident light in the vehicular camera according to the first embodiment;

FIG. 14 is a cross-sectional view of the vehicular camera according to the second embodiment taken along a line I-I in FIG. 9;

FIG. 15 illustrates a state in which a planar member is attached to the lens barrel illustrated in FIG. 11 in the vehicular camera according to the second embodiment; and

FIG. 16 is an image diagram illustrating an optical path of incident light in the vehicular camera according to the second embodiment.

### DESCRIPTION OF EMBODIMENTS

Hereinafter, embodiments that specifically disclose a vehicular camera according to the present disclosure will be described in detail with reference to the drawings as appropriate. However, unnecessarily detailed descriptions may be omitted. For example, detailed descriptions of already well-known matters and redundant descriptions of substantially the same configuration may be omitted. This is to avoid unnecessary redundancy of the following descriptions and to facilitate understanding of those skilled in the art. It should be noted that the accompanying drawings and the following description are provided for those skilled in the art to sufficiently understand the present disclosure, and are not intended to limit the subject matter described in the claims.

### Vehicle on which Vehicular Cameras are Mounted

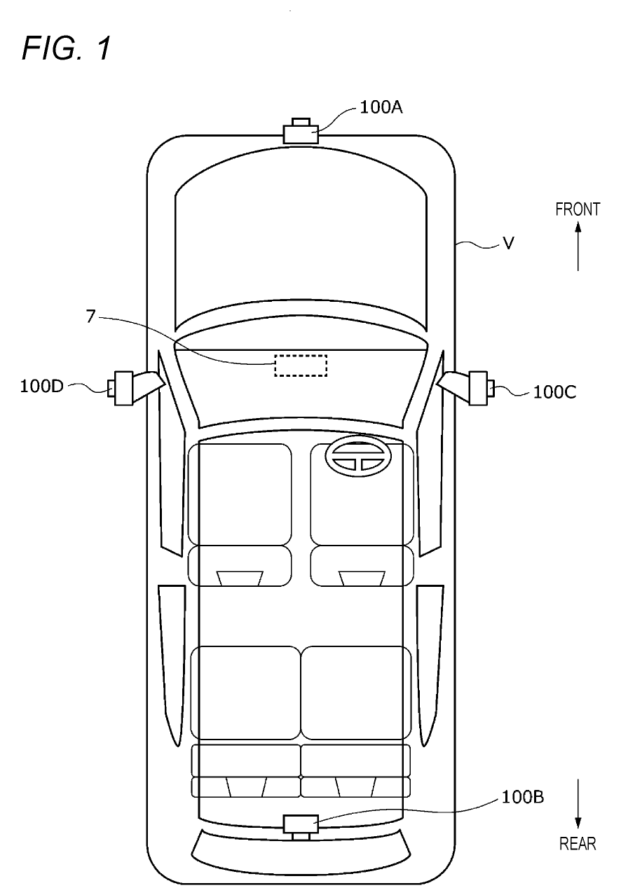

FIG. 1 is an example of a vehicle, and is a top view of the vehicle on which vehicular cameras are mounted. As a vehicular camera 100, a vehicular camera 100A, a vehicular camera 100B, a vehicular camera 100C, and a vehicular camera 100D are mounted on a vehicle V. The vehicular camera 100A is a front camera, the vehicular camera 100B is a rear camera, the vehicular camera 100C is a right side camera, and the vehicular camera 100D is a left side camera. The vehicular cameras 100A to 100D are, for example, wide-angle cameras having an angle of view of about 180°, and are disposed to capture images illustrating an entire periphery of the vehicle V.

For example, the vehicular camera 100A is provided in a front grille of the vehicle V, and captures an image of a front region in a direction of looking down obliquely with respect to the ground. The vehicular camera 100B is provided in a roof spoiler of the vehicle V, and captures an image of a rear region in a direction of looking down obliquely with respect to the ground. The vehicular camera 100C and the vehicular camera 100D are provided in side mirrors of the vehicle V, and capture images of lateral regions in directions of looking down obliquely with respect to the ground, respectively.

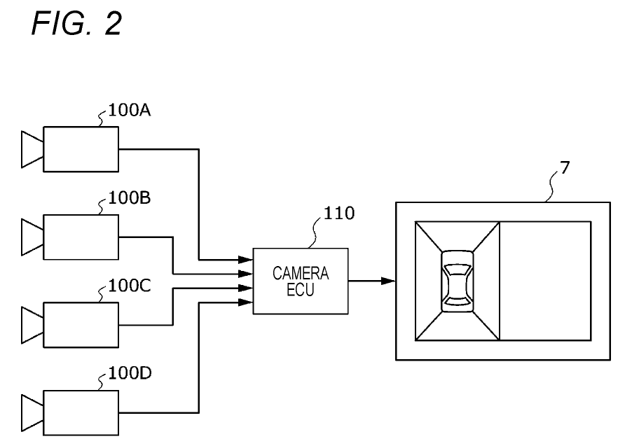

FIG. 2 is a block diagram illustrating a connection example of the vehicular cameras 100A to 100D provided in the vehicle V illustrated in FIG. 1, a camera ECU 110, and a display 7. The camera electronic control unit (ECU) 110 in FIG. 2 synthesizes the images captured by the vehicular cameras 100A to 100D, and displays a synthesized image on the display 7 of a navigation system disposed on an instrument panel, for example. An occupant can visually recognize the display 7 and check a situation around the vehicle V.

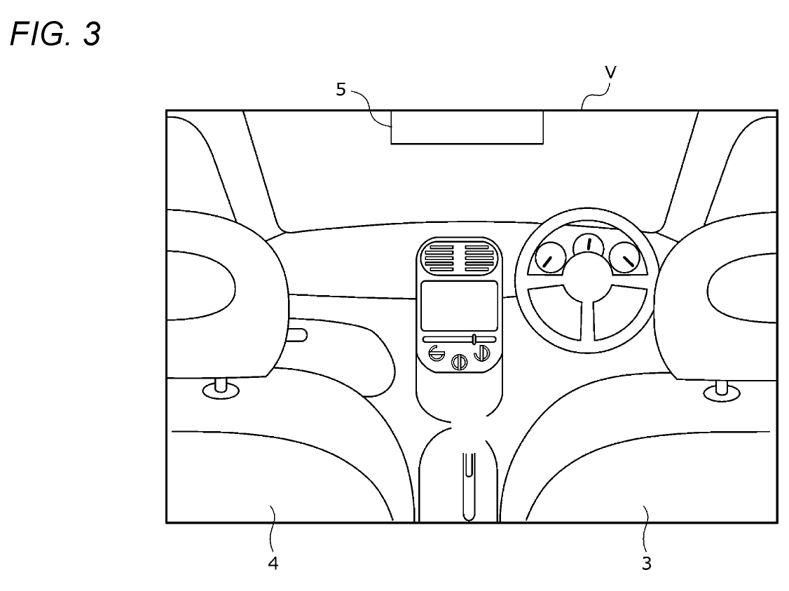

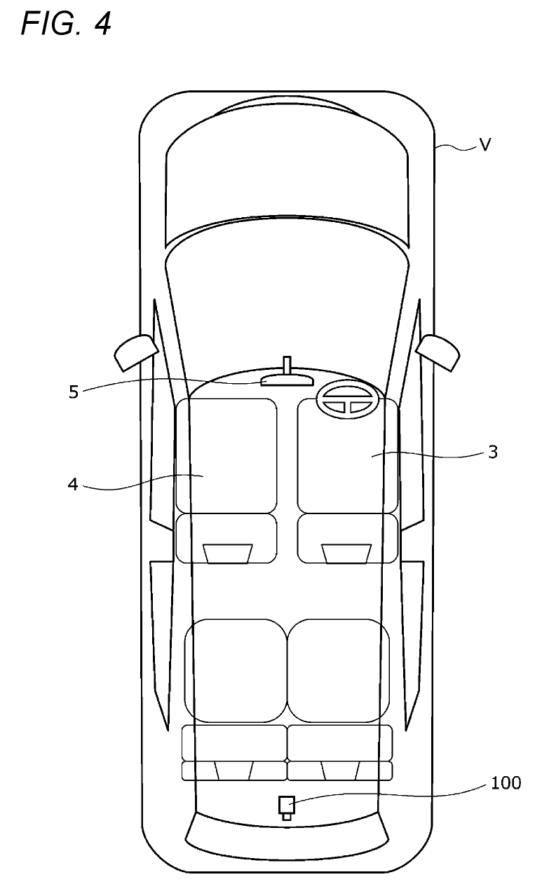

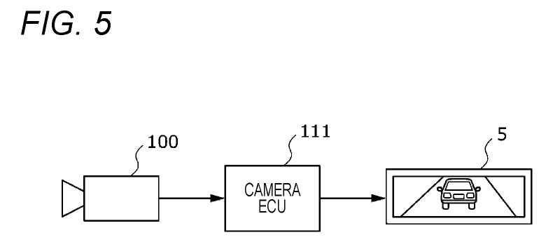

FIG. 3 is another example of the vehicle, and is a schematic diagram of a cabin of the vehicle on which the vehicular camera is mounted, and FIG. 4 is a top view of the vehicle in FIG. 3. The vehicle V includes a display device 5 (for example, an electronic rearview mirror) at an attachment position of a rearview mirror, which is a front portion between a driver's seat 3 and a passenger seat 4 in a cabin 2. Further, the vehicle V is provided with the vehicular camera 100 at a rear side of a vehicle body. FIG. 5 is a block diagram illustrating a connection example of the vehicular camera 100 provided in the vehicle V illustrated in FIG. 3, a camera ECU 111, and the display device 5. The camera electronic control unit (ECU) 111 in FIG. 4 processes an image captured by the vehicular camera 100, and the display device 5 displays the image. The occupant can visually recognize the display device 5 and check a rear situation of the vehicle V.

### First Embodiment of Vehicular Camera

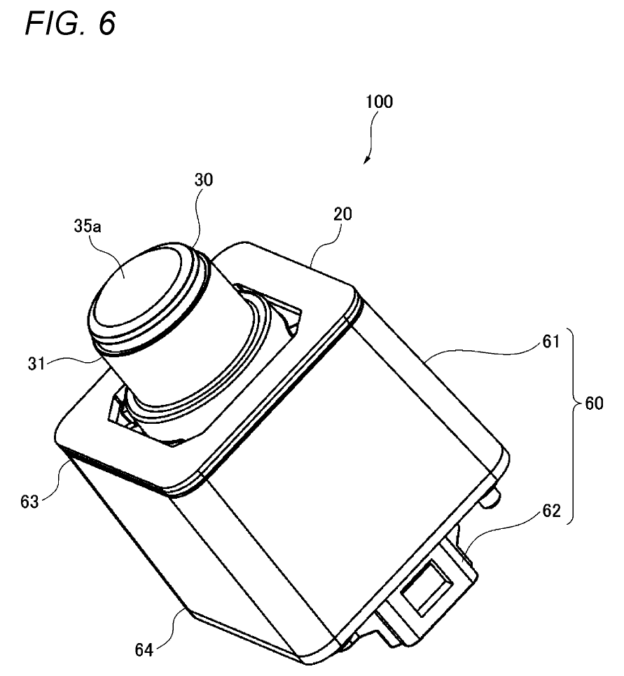

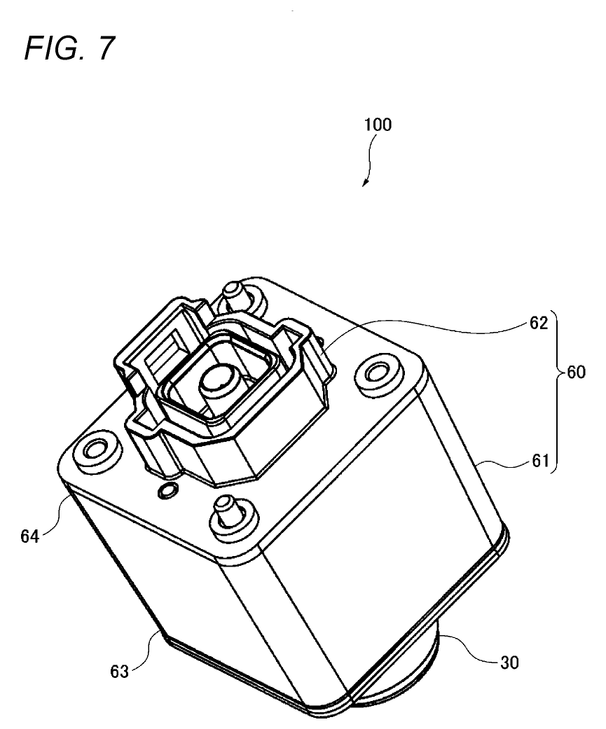

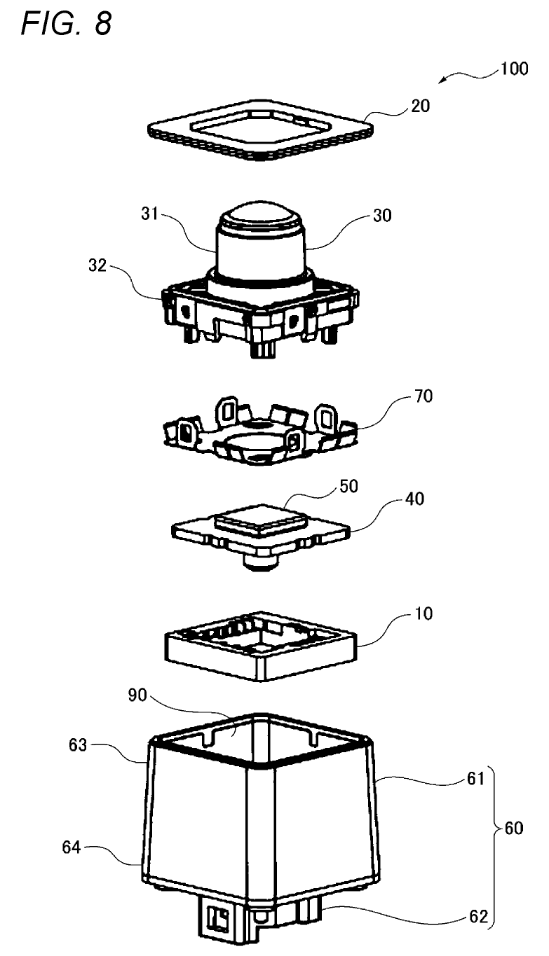

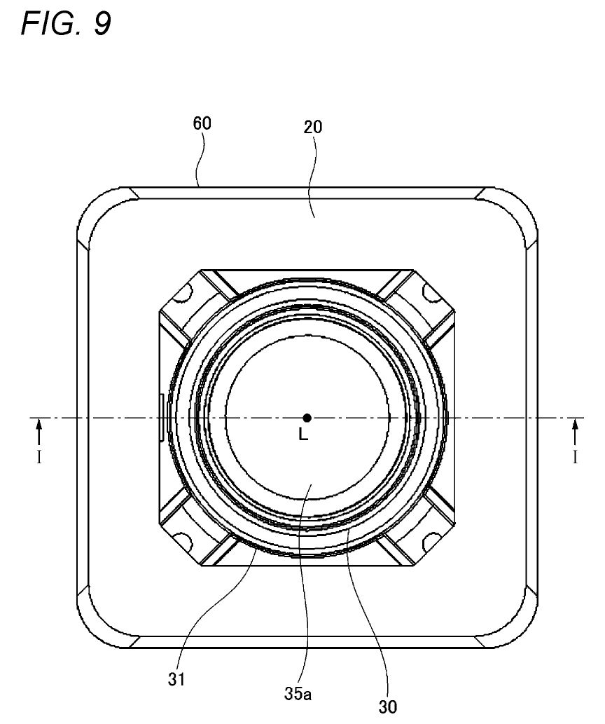

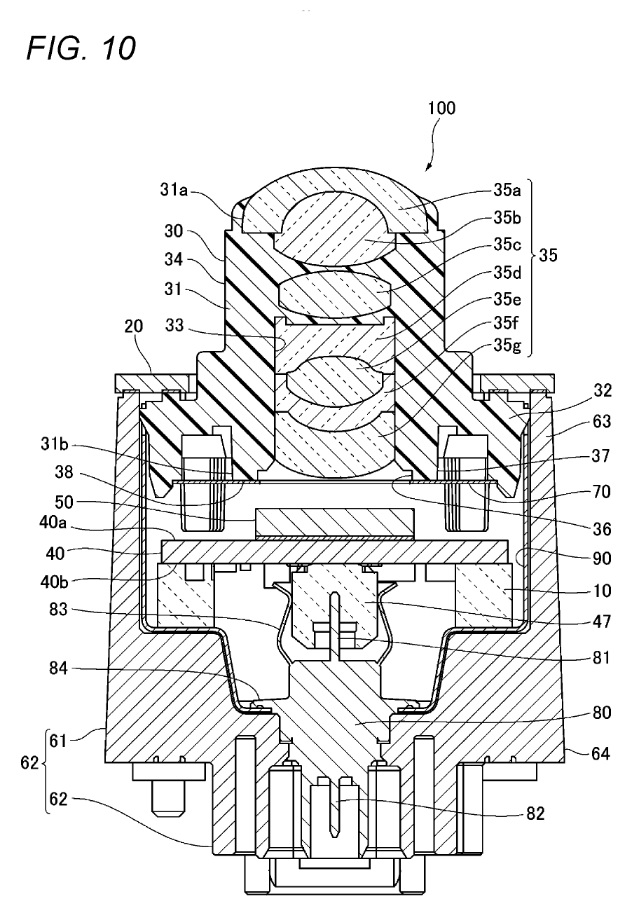

FIG. 6 is a front perspective view of the vehicular camera 100 according to a first embodiment. FIG. 7 is a rear perspective view of the vehicular camera 100 according to the first embodiment. FIG. 8 is an exploded perspective view of the vehicular camera 100 according to the first embodiment. FIG. 9 is a top view of the vehicular camera 100 according to the first embodiment. FIG. 10 is a cross-sectional view taken along a line I-I in FIG. 9. Coordinates including an X axis along one side of the vehicular camera 100, a Y axis orthogonal to the X axis and along another side of the vehicular camera 100, and a Z axis orthogonal to the X axis and the Y axis and along a height direction of the vehicular camera 100 are defined, and are used in the following description.

The vehicular camera 100 according to the present embodiment includes a ring member 20, a lens barrel 30, a circuit board 40, an imaging element 50, a housing 60, a planar member 70, and a resin member 10.

The lens barrel 30 has a first tubular portion 31 along an optical axis L (a direction orthogonal to the sheet of FIG. 9 and along the Z axis). The first tubular portion 31 has a first end portion 31a and a second end portion 31b opposite to the first end portion 31a in a direction along the optical axis L. The first tubular portion 31 has a lens barrel inner surface 33 and a lens barrel outer surface 34. The lens barrel inner surface 33 has a cylindrical surface in the present embodiment. The lens barrel inner surface 33 may have a stepped portion instead of a flat surface. The lens barrel outer surface 34 is located farther outward than the inner surface 33 with respect to the optical axis L, and has a cylindrical surface in the present embodiment.

The first end portion 31a forms a distal end portion of the lens barrel 30, and at least a part of the second end portion 31b faces the circuit board 40 inside the housing 60. The second end portion 31b has a second end portion inner surface 36 disposed over an entire circumference centering on the optical axis L, and a second end portion outer surface 37 disposed over the entire circumference centering on the optical axis L and located farther outward than the second end portion inner surface 36 with respect to the optical axis L. Further, the second end portion 31b has a second end surface 38 facing at least a first surface 40a of the circuit board 40.

The lens barrel 30 includes, at a position radially inward of the lens barrel inner surface 33, a lens 35 that is accommodated inside the first tubular portion and disposed on the optical axis L. In the present embodiment, the lens 35 includes a first lens 35a, a second lens 35b, a third lens 35c, a fourth lens 35d, a fifth lens 35e, a sixth lens 35f, and a seventh lens 35g, which are arranged in a state in which respective optical axes L coincide with each other, and constitutes a lens group used for capturing images of the inside and outside of the vehicle body of the vehicle V.

The lens barrel 30 has a flange portion 32 disposed outside the first tubular portion 31 to extend outward with respect to the optical axis L over the entire circumference centering on the optical axis L. The flange portion 32 has a first flange surface 32a and a second flange surface 32b. As will be described later, the lens barrel 30 is connected to the housing 60 via the flange portion 32 and the ring member 20.

The imaging element 50 is disposed in an internal space of the housing 60 on the optical axis L and closer to the second end portion 31b than the first end portion 31a of the first tubular portion of the lens barrel 30. The imaging element 50 is electrically connected to a circuit of the circuit board 40, and can capture an image by directing external light to the imaging element 50. The imaging element 50 may be, for example, a complementary metal-oxide-semiconductor (CMOS) image sensor.

The circuit board 40 is disposed in the internal space of the housing 60, and includes a first surface 40a and a second surface 40b opposite to the first surface 40a. However, two or more circuit boards may be provided. The imaging element 50 is disposed on the first surface 40a of the circuit board 40.

The circuit board 40 has a first shape in a plan view. The first shape in the plan view is a shape when viewed in a direction from the first surface 40a to the second surface 40b of the circuit board 40. The first shape is, for example, a quadrangular shape as in the embodiment, but may be a polygonal shape having five or more sides.

The housing 60 is a tubular member along the optical axis L. The housing 60 includes a second tubular portion 61 and a third tubular portion 62 having a smaller diameter than the second tubular portion. The second tubular portion 61 has a second tubular shape along the optical axis L, and has a third end portion 63 and a fourth end portion 64 opposite to the third end portion 63. The housing 60 serves to accommodate at least the circuit board 40 and the imaging element 50 while supporting the lens barrel 30.

The third end portion 63 of the second tubular portion 61 is connected to the lens barrel 30. The fourth end portion 64 of the second tubular portion 61 is opposite to the third end portion 63 in the direction along the optical axis L, and is disposed farther away from the first end portion 31a of the first tubular portion of the lens barrel 30 than the third end portion 63. In the present embodiment, the housing 60 has a rectangular tubular shape, but is not limited thereto, and may have a polygonal tubular shape other than the rectangular tubular shape, a circular or elliptical tubular shape, or another tubular shape.

In a state in which the housing 60 accommodates at least the circuit board 40 and the imaging element 50, the flange portion 32 of the lens barrel 30 is connected to the third end portion 63 of the second tubular portion 61 of the housing 60 via the ring member 20. The connection is performed by, for example, laser welding. For example, the ring member 20 is laser-welded to the first flange surface 32a of the flange portion 32 by laser, and then the ring member 20 is laser-welded to the third end portion 63 of the second tubular portion 61 of the housing 60 by laser.

The planar member 70 is made of metal, and serves to shield noise generated inside and outside the vehicular camera 100 and reduce influence on imaging by the imaging element 50. The planar member 70 is disposed between the second end portion 31b of the first tubular portion 31 of the lens barrel 30 and the first surface 40a of the circuit board 40 along a direction parallel to the first surface 40a of the circuit board 40. The planar member 70 has a third surface 71 at least a part of which faces the second end portion 31b of the lens barrel 30, a fourth surface 72 opposite to the third surface 71, and a light passage hole 73 through which the optical axis L passes and which penetrates the third surface 71 and the fourth surface 72. The light passage hole 73 includes a planar member inner surface 73a connecting the third surface 71 and the fourth surface 72 of the planar member 70.

The resin member 10 made of resin is accommodated inside the second tubular portion 61 of the housing 60 while being in contact with the second surface 40b of the circuit board 40. The resin member 10 serves to dissipate heat generated from the circuit board 40 to the outside, for example.

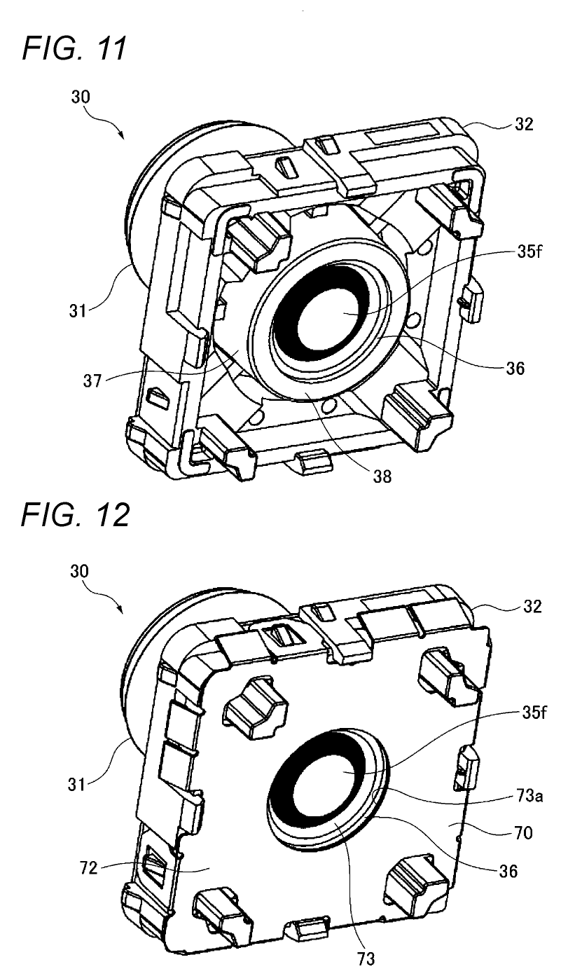

FIG. 11 is a rear perspective view of the lens barrel 30 in the vehicular camera 100 according to the first embodiment. FIG. 12 illustrates a state in which the planar member 70 is attached to the lens barrel 30 of FIG. 11. The incident light incident on the first lens 35a from the outside of the vehicular camera 100 passes through the second lens 35b, the third lens 35c, the fourth lens 35d, the fifth lens 35e, and the sixth lens 35f in this order, passes through the light passage hole 73 of the planar member 70, and reaches the imaging element 50.

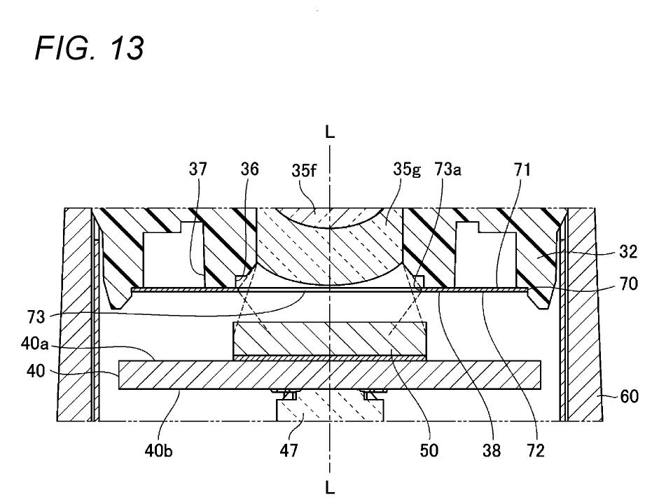

FIG. 13 is an image diagram illustrating an optical path of incident light in the vehicular camera 100 according to the first embodiment. The incident light indicated by the broken line passes through the sixth lens 35f and then reaches the imaging element 50.

In the present embodiment, the planar member inner surface 73a defining the light passage hole 73 of the planar member 70 is provided at a position coinciding with the second end portion inner surface 36 of the second end portion 31b in a radial direction (an X direction and a Y direction). In order to ensure the noise shielding performance of the planar member 70, it is desirable to make a diameter of the light passage hole 73 as small as possible. However, when the diameter is too small, the amount of incident light that can pass through the light passage hole 73 decreases. From the viewpoint of the balance between the assurance of the noise shielding performance and the assurance of the amount of incident light, the position of the planar member inner surface 73a, that is, the diameter of the light passage hole 73 is set as illustrated in FIG. 13.

When the position of the planar member inner surface 73a is set to the position illustrated in FIG. 13, there is a possibility that outermost light of incident light passing through the seventh lens 35g (light located on an outermost side in the radial direction among the incident light) passes through a side (outward than the lens barrel inner surface 33 and the planar member inner surface 73a in the radial direction when viewed from the optical axis L) farther from the optical axis L than a position of the lens barrel inner surface 33, that is, the position of the planar member inner surface 73a. In such a case, the outermost light of the incident light may strike the planar member inner surface 73a and be reflected, and the reflected light may be incident on the imaging element 50. Since the reflected light is naturally not light to be imaged, a defect such as flare may occur.

### Second Embodiment of Vehicular Camera

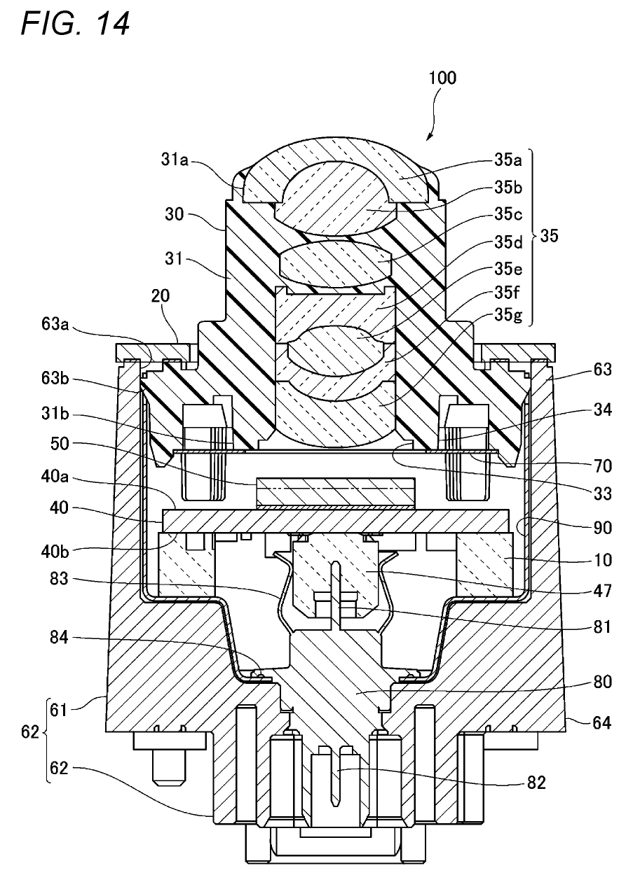

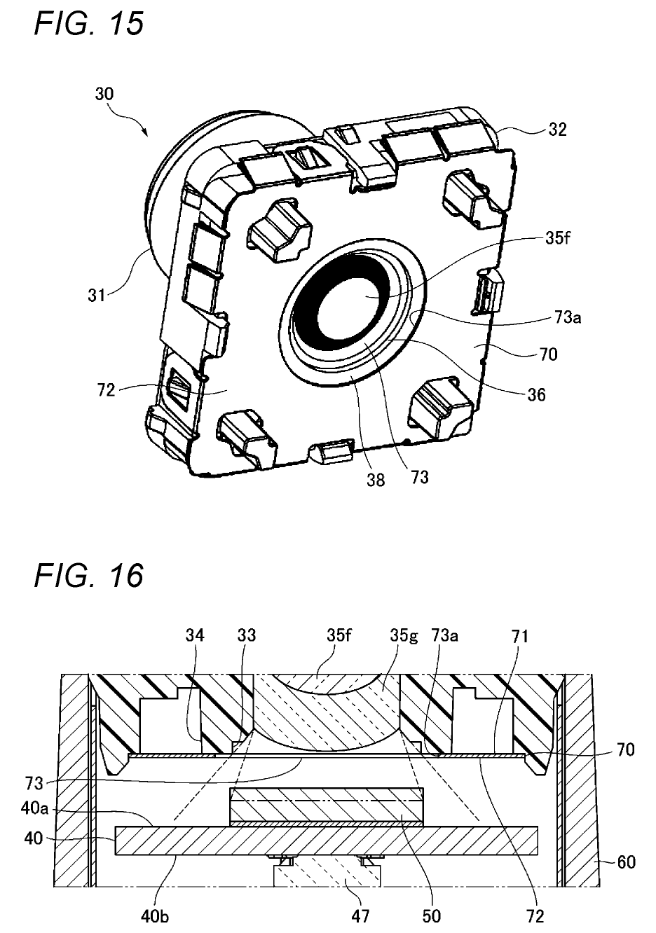

FIG. 14 is a cross-sectional view of the vehicular camera 100 according to a second embodiment taken along a line I-I in FIG. 9, and corresponds to FIG. 10 of the first embodiment. FIG. 15 illustrates a state in which a planar member is attached to the lens barrel illustrated in FIG. 11 in the vehicular camera 100 according to the second embodiment, and corresponds to FIG. 12 of the first embodiment. The appearance of the vehicular camera 100 according to the second embodiment is the same as the appearance in the first embodiment.

In the second embodiment, the diameter of the light passage hole 73 of the planar member 70 is set to be larger than that of the first embodiment. That is, the position of the planar member inner surface 73a of the light passage hole 73 is set radially outward of the second end portion inner surface 36 of the second end portion 31b of the lens barrel 30 and inward of the second end portion outer surface 37.

FIG. 16 is an image diagram illustrating an optical path of incident light in the vehicular camera 100 according to the second embodiment, and corresponds to FIG. 13 of the first embodiment. In the present embodiment, the incident light incident on the first lens 35a passes through other lenses and the light passage hole 73 and reaches the imaging element 50, and the outermost light, which is light located on an outermost side among the incident light, passes through a side (inward than the second end portion inner surface 36 and the planar member inner surface 73a in the radial direction when viewed from the optical axis L) closer to the optical axis L than the planar member inner surface 73a of the light passage hole 73 of the planar member 70.

Unlike the first embodiment, in the second embodiment, since the outermost light of the incident light does not strike the planar member inner surface 73a, the reflected light is not generated. That is, the incident light can pass through the light passage hole 73 without being obstructed by the planar member inner surface 73a of the planar member 70. Therefore, it is possible to prevent the occurrence of defects such as flare.

The above configuration is achieved by adjusting a position of a lens from which the incident light finally exits after passing through a lens on which the incident light first enters, and the positions of the lens barrel inner surface 33 and the planar member inner surface 73a. Therefore, it is assumed that the lens 35 includes at least two lenses, that is, a lens disposed closer to the first end portion 31a than the second end portion 31b of the lens barrel 30, for example, the first lens 35a, and a lens disposed closer to the second end portion 31b than the first lens 35a, for example, the second lens 35b.

The planar member inner surface 73a of the light passage hole 73 of the planar member 70 is located between the second end portion inner surface 36 and the second end portion outer surface 37 of the second end portion 31b of the first tubular portion 31 of the lens barrel 30 in the radial direction orthogonal to the optical axis L, for example. Accordingly, the incident light is reliably prevented from being reflected by the planar member inner surface 73a of the planar member 70 to generate the reflected light, and thus it is possible to prevent the reflected light from reaching the imaging element 50 and prevent occurrence of defects such as flare.

More specifically, the planar member inner surface 73a of the light passage hole 73 of the planar member 70 is disposed closer to the second end portion outer surface 37 than the second end portion inner surface 36 in the radial direction orthogonal to the optical axis L. Accordingly, the possibility that the incident light is reflected by the planar member inner surface 73a of the planar member 70 can be further reduced, and the generation of the reflected light can be further prevented.

The second end portion 31b of the first tubular portion 31 of the lens barrel 30 has at least a second end surface 38 facing the first surface 40a of the circuit board 40. The planar member 70 is disposed closer to the second end surface 38 than the first surface 40a of the circuit board 40 in the direction along the optical axis L. Accordingly, the planar member 70 can be disposed closer to the lens barrel 30 than the circuit board 40.

The planar member 70 is disposed along the second end surface 38. Accordingly, the planar member 70 can be disposed near the second end portion 31b.

The planar member 70 is attached to the flange portion 32 of the lens barrel 30. Accordingly, the planar member 70 can be attached to the lens barrel 30.

In the embodiment, the light passage hole 73 of the planar member 70 is circular. Accordingly, the light passage hole 73 can be easily formed.

The vehicular camera 100 further includes a metallic shield member 90 that is disposed inside the housing 60 and accommodates at least the circuit board 40. The planar member 70 is electrically connected to the shield member 90. Accordingly, the noise inside and outside the housing can be shielded by the metallic planar member 70 and the metallic shield member 90.

In the embodiment, the planar member 70 has a first quadrangular shape in a plan view, and the shield member 90 has a second quadrangular shape in a cross-sectional view. Each of four sides of the first quadrangular shape of the planar member 70 is electrically connected to each of four sides of the second quadrangular shape of the shield member 90. Accordingly, the electrical connection between the planar member 70 and the shield member 90 can be easily and reliably secured.

As illustrated in FIG. 11, the vehicular camera 100 further includes a circuit board connector 47 disposed on the circuit board 40 and a connector 80 disposed in at least a part of the fourth end portion 64 of the housing 60. The connector 80 has a first connector end portion 81 and a second connector end portion 82 opposite to the first connector end portion 81, the first connector end portion 81 is connected to the circuit board connector 47, and the second connector end portion 82 is connected to a wire of the vehicle V when the vehicular camera 100 is disposed in the vehicle V. Accordingly, power can be supplied from the vehicle to the circuit board 40 via the connector 80 and the circuit board connector 47.

The connector 80 may be a coaxial connector having a signal terminal 83 and a ground terminal 84. Accordingly, the connector 80 can achieve both signal supply and grounding.

The housing 60 is made of, for example, resin. Accordingly, the housing 60 can be formed easily and inexpensively.

The housing may be considered to include the housing 60 and the ring member 20. The housing may be considered to include the housing 60 and the flange portion 32 of the lens barrel 30. The housing may be considered to include the housing 60, the ring member 20, and the flange portion 32. Therefore, a support portion that supports the lens barrel 30 may be considered to include the third end portion 63 of the second tubular portion 61 of the housing 60 and the ring member 20.

The support portion that supports the lens barrel 30 may be considered to include the third end portion 63 of the second tubular portion 61 of the housing 60 and the flange portion 32 of the lens barrel 30. The support portion that supports the lens barrel 30 may be considered to include the third end portion 63 of the second tubular portion 61 of the housing 60, the ring member 20, and the flange portion 32 of the lens barrel 30. Further, only the third end portion 63 of the second tubular portion 61 of the housing 60 may be regarded as the support portion that supports the lens barrel 30.

As described above, at least the following matters are described in the present disclosure. Components corresponding to those in the embodiment are illustrated in parentheses, but the present disclosure is not limited thereto.

(1) A vehicular camera (vehicular camera 100) including:

a lens barrel (lens barrel 30) including a first tubular portion (first tubular portion 31) having a first tubular shape along an optical axis (optical axis L) and having a first end portion (first end portion 31a), a second end portion (second end portion 31b) opposite to the first end portion, a lens barrel inner surface (lens barrel inner surface 33) and a lens barrel outer surface (lens barrel outer surface 34), and a lens (lens 35) disposed inside the first tubular portion;

an imaging element (imaging element 50) disposed on the optical axis and closer to the second end portion than the first end portion of the first tubular portion of the lens barrel;

a circuit board (circuit board 40) having a first surface (first surface 40a) and a second surface (second surface 40b) opposite to the first surface, the imaging element being disposed on the first surface;

a housing (housing 60) including a second tubular portion (second tubular portion 61) having a second tubular shape along the optical axis and having a third end portion (third end portion 63) and a fourth end portion (fourth end portion 64) opposite to the third end portion, and configured to support the lens barrel and accommodate at least the imaging element and the circuit board; and

a planar member (planar member 70) made of metal and disposed between the second end portion of the first tubular portion of the lens barrel and the first surface of the circuit board along a direction parallel to the first surface of the circuit board, in which the lens of the lens barrel includes a first lens (first lens 35a) disposed inside the first tubular portion and closer to the first end portion than the second end portion, and the planar member includes a third surface (third surface 71), a fourth surface (fourth surface 72) opposite to the third surface, and a light passage hole (light passage hole 73) through which the optical axis passes and which penetrates the third surface and the fourth surface, the light passage hole includes a planar member inner surface (planar member inner surface 73a) connecting the third surface and the fourth surface of the planar member, and incident light incident on the first lens passes through the second lens and the light passage hole and reaches the imaging element, and outermost light, which is light located on an outermost side among the incident light, passes through a side closer to the optical axis than the planar member inner surface of the planar member.

Accordingly, the incident light can pass through the light passage hole without being obstructed by the planar member inner surface of the planar member.

(2) The vehicular camera according to (1), in which the second end portion of the first tubular portion of the lens barrel includes a second end portion inner surface (second end portion inner surface 36) located over an entire circumference centering on the optical axis, and a second end portion outer surface (second end portion outer surface 37) located over the entire circumference centering on the optical axis and farther outward than the second end portion inner surface with respect to the optical axis, and the planar member inner surface of the light passage hole of the planar member is located between the second end portion inner surface and the second end portion outer surface of the second end portion of the first tubular portion of the lens barrel in a direction orthogonal to the optical axis.

Accordingly, the incident light is reliably prevented from being reflected by the planar member inner surface of the planar member to generate the reflected light, and thus it is possible to prevent the reflected light from reaching the imaging element and prevent occurrence of defects such as flare.

(3) The vehicular camera according to (2), in which the planar member inner surface of the light passage hole of the planar member is disposed closer to the second end portion outer surface than the second end portion inner surface of the first tubular portion of the lens barrel in the direction orthogonal to the optical axis.

Accordingly, the possibility that the incident light is reflected by the planar member inner surface of the planar member can be further reduced, and the generation of the reflected light can be further prevented.

(4) The vehicular camera according to (1), in which the second end portion of the first tubular portion of the lens barrel has at least a second end surface (second end surface 38) facing the first surface of the circuit board, and the planar member is disposed closer to the second end surface than the first surface of the circuit board in the direction along the optical axis.

Accordingly, the planar member can be disposed closer to the lens barrel than the circuit board.

(5) The vehicular camera according to (4), in which the planar member is disposed along the second end surface.

Accordingly, the planar member can be disposed near the second end portion.

(6) The vehicular camera according to (5), in which the lens barrel further includes a flange portion (flange portion 32) disposed outside the first tubular portion of the lens barrel to extend outward with respect to the optical axis L over the entire circumference centering on the optical axis L, and the planar member is attached to the flange portion of the housing.

Accordingly, the planar member can be attached to the lens barrel.

(7) The vehicular camera according to (1), in which the light passage hole of the planar member is circular.

Accordingly, the light passage hole can be easily formed.

(8) The vehicular camera according to (1), further including: a shield member (shield member 90) made of metal, disposed inside the housing, and configured to accommodate at least the circuit board, in which the planar member is electrically connected to the shield member.

Accordingly, the noise inside and outside the housing can be shielded by the metallic planar member and the metallic shield member.

(9) The vehicular camera according to (8), in which the planar member has a first quadrangular shape in a plan view, the shield member has a second quadrangular shape in a cross-sectional view, and each of four sides of the first quadrangular shape of the planar member is electrically connected to each of four sides of the second quadrangular shape of the shield member.

Accordingly, the electrical connection between the planar member and the shield member can be easily and reliably secured.

(10) The vehicular camera according to (1), further including: a circuit board connector (circuit board connector 47) disposed on the circuit board; and a connector (connector 80) disposed in at least a part of the fourth end portion of the housing, in which the connector includes a first connector end portion (first connector end portion 81), and a second connector end portion (second connector end portion 82) opposite to the first connector end portion, the first connector end portion is connected to the circuit board connector, and the second connector end portion is connected to a wire of a vehicle when the vehicular camera is disposed in the vehicle.

Accordingly, power can be supplied from the vehicle to the circuit board via the connector and the circuit board connector.

(11) The vehicular camera according to (10), in which the connector is a coaxial connector including a signal terminal (signal terminal 83) and a ground terminal (ground terminal 84).

Accordingly, the connector can achieve both signal supply and grounding.

(12) The vehicular camera according to (1), in which the housing is made of resin.

Accordingly, the housing can be formed easily and inexpensively.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiments described above may be combined freely in a range without departing from the gist of the invention.

### INDUSTRIAL APPLICABILITY

The present disclosure is useful for a vehicular camera in which incident light passes through a light passage hole without being obstructed by a planar member inner surface of a planar member.

### CROSS-REFERENCE TO RELATED APPLICATIONS

This application is based on and claims priority under 35 USC 119 from Japanese Patent Application No. 2025-007758 filed on January 20, 2025, the contents of which are incorporated herein by reference.

What is claimed is:

1. A vehicular camera comprising:
a lens barrel including
a first tubular portion having a first tubular shape along an optical axis and having a first end portion, a second end portion opposite to the first end portion, a lens barrel inner surface and a lens barrel outer surface, and
a lens disposed inside the first tubular portion;
an imaging element disposed on the optical axis and closer to the second end portion than the first end portion of the first tubular portion of the lens barrel;
a circuit board having a first surface and a second surface opposite to the first surface, the imaging element being disposed on the first surface;
a housing including a second tubular portion having a second tubular shape along the optical axis and having a third end portion and a fourth end portion opposite to the third end portion, and configured to support the lens barrel and accommodate at least the imaging element and the circuit board; and
a planar member made of metal and disposed between the second end portion of the first tubular portion of the lens barrel and the first surface of the circuit board along a direction parallel to the first surface of the circuit board, wherein
the lens of the lens barrel includes
a first lens disposed inside the first tubular portion and closer to the first end portion than the second end portion, and
a second lens disposed inside the first tubular portion and closer to the second end portion than the first lens,
the planar member includes
a third surface,
a fourth surface opposite to the third surface, and
a light passage hole through which the optical axis passes and which penetrates the third surface and the fourth surface,
the light passage hole includes a planar member inner surface connecting the third surface and the fourth surface of the planar member, and
incident light incident on the first lens passes through the second lens and the light passage hole and reaches the imaging element, and outermost light, which is light located on an outermost side among the incident light, passes through a side closer to the optical axis than the planar member inner surface of the planar member.

2. The vehicular camera according to claim 1, wherein
the second end portion of the first tubular portion of the lens barrel includes
a second end portion inner surface located over an entire circumference centering on the optical axis, and
a second end portion outer surface located over the entire circumference centering on the optical axis and farther outward than the second end portion inner surface with respect to the optical axis, and
the planar member inner surface of the light passage hole of the planar member is located between the second end portion inner surface and the second end portion outer surface of the second end portion of the first tubular portion of the lens barrel in a direction orthogonal to the optical axis.

3. The vehicular camera according to claim 2, wherein
the planar member inner surface of the light passage hole of the planar member is disposed closer to the second end portion outer surface than the second end portion inner surface of the first tubular portion of the lens barrel in the direction orthogonal to the optical axis.

4. The vehicular camera according to claim 1, wherein
the second end portion of the first tubular portion of the lens barrel has at least a second end surface facing the first surface of the circuit board, and
the planar member is disposed closer to the second end surface than the first surface of the circuit board in the direction along the optical axis.

5. The vehicular camera according to claim 4, wherein
the planar member is disposed along the second end surface of the second end portion of the first tubular portion of the lens barrel.

6. The vehicular camera according to claim 5, wherein
the lens barrel further includes a flange portion disposed outside the first tubular portion of the lens barrel to extend outward with respect to the optical axis over the entire circumference centering on the optical axis, and
the planar member is attached to the flange portion of the housing.

7. The vehicular camera according to claim 1, wherein
the light passage hole of the planar member is circular.

8. The vehicular camera according to claim 1, further comprising:
a shield member made of metal, disposed inside the housing, and configured to accommodate at least the circuit board, wherein
the planar member is electrically connected to the shield member.

9. The vehicular camera according to claim 8, wherein
the planar member has a first quadrangular shape in a plan view,
the shield member has a second quadrangular shape in a cross-sectional view, and
each of four sides of the first quadrangular shape of the planar member is electrically connected to each of four sides of the second quadrangular shape of the shield member.

10. The vehicular camera according to claim 1, further comprising:
a circuit board connector disposed on the circuit board; and
a connector disposed in at least a part of the fourth end portion of the housing, wherein
the connector includes
a first connector end portion, and
a second connector end portion opposite to the first connector end portion,
the first connector end portion is connected to the circuit board connector, and
the second connector end portion is connected to a wire of a vehicle when the vehicular camera is disposed in the vehicle.

11. The vehicular camera according to claim 10, wherein
the connector is a coaxial connector having a signal terminal and a ground terminal.

12. The vehicular camera according to claim 1, wherein
the housing is made of resin.
